(19) United States
(12) Patent Application Publication
(10) Pub. No.: US 2004/0213905 A1
(43) Pub. Date: Oct. 28, 2004

(54) Treatment fluids and methods for consolidating substrates without simultaneous substantial loss of permeability

(76) Inventors: Christopher Breen, Sheffield (GB); Francis Clegg, South Yorkshire (GB); Geoffrey Colin Maitland, Cambridgeshire (GB)

Correspondence Address: SCHLUMBERGER-DOLL RESEARCH, 36 OLD QUARRY ROAD, RIDGEFIELD, CT, 06877-4108, US

(21) Appl. No.: 10/476,122

(22) PCT Filed: Apr. 26, 2002
(86) PCT No.: PCT/GB02/01960

(30) Foreign Application Priority Data
Apr. 30, 2001 (GB) 0110531.1

(51) Int. Cl. B05D 7/22; B05D 3/00

(52) U.S. Cl. 427/230; 427/299

(57) ABSTRACT

The invention relates to a treatment fluid for consolidating an unconsolidated or weakly consolidated granular porous substrate without simultaneous substantial loss of permeability and a method for doing the same. According to the invention, the treatment fluid comprises a solvent;—a surfactant, in a concentration sufficient to form admicelles at the surface of grains of the substrate; and—at least one compound comprising a functional group able to polymerise, together, where appropriate, with a polymerisation initiator. The invention can be implemented, in particular, for consolidating sandstone of a rock formation.

### FIELD OF THE INVENTION

The present invention relates to treatment fluids for consolidating or stabilising substrates, notably, unconsolidated or weakly consolidated granular porous substrates without simultaneous substantial loss of permeability and methods for doing the same. More particularly, the unconsolidated granular porous substrates of the invention are sand stones that may be found down hole in an oil well.

### PRIOR ART

A major problem in the course of oil production from a reservoir comprising weakly consolidated sandstone is the production of sand alongside oil, water and gas. Several approaches are currently used to avoid sand production.

First approaches are based on the down hole implementation of mechanical devices such as screens or gravel packs. These devices filter out the sand, preventing it reaching the well bore.

Second approaches are based on the use of chemical fluids, typically epoxy or furan based resins. These chemical fluids are injected into the unconsolidated rock as a low viscosity liquid. Then, they harden in situ, binding the sand rock grains together and permitting the consolidation of the rock by increasing its mechanical strength. Such second approaches involve numerous steps, practically four to six steps, with attendant high costs and production losses. Moreover, the resin fills the sandstone pore spaces between the sand grains, blocks said pore spaces, such that it results in a significant decrease in sand permeability compared with the original untreated formation. More precisely, unconfined compressive strength (UCS) values of. 1000 psi are relatively easy to achieve using the range of chemistries in conventional resin treatments but they result in substantial loss of permeability. This, in turn, may reduce the productivity of oil and gas alongside reducing sand production. That is the reason why, practically, part of the complexity of these approaches arises from the need to flush out the excess resin material filling the pore spaces before it results in permanent formation damage. An alternative is to accept that the resin injection and hardening steps of the conventional consolidation process significantly impair the permeability of the rocks and to implement a subsequent fracturing treatment through the treated consolidated zone that permits to enhance oil and gas productivity to acceptable levels.

A third approach exploits the fact that unconsolidated or weakly consolidated sandstone, at residual water conditions, contains water only in limited regions close to the sand grains contact points where wedges of liquid are retained in place by capillary forces. A tetraalkoxysilane, dissolved in a hydrocarbon carrier, may be then injected into the formation, where it reacts with water and forms silica and methanol as a by-product. The silica formed constitutes bridges, located at the contact points of the sand grains preferentially, which might result in consolidation of the sandstone without significant permeability impairment as long as no water resides in the bulk pore space. The treatment is practically difficult to implement except in very particular borehole conditions, due to, in particular, the water sensitivity of the tetraalkoxysilane.

### SUMMARY OF THE INVENTION

Considering the above state of the art, a technical problem that is intended to be solved by the invention is to provide a treatment fluid for consolidating or stabilising substrates, in particular unconsolidated or weakly consolidated granular porous substrates without simultaneous substantial loss of permeability and a method for doing the same.

As a solution to that problem, the invention concerns, in a first aspect, a treatment fluid comprising:—a solvent;—a surfactant, in a concentration sufficient to form admicelles at the surface of grains of said substrate; and—at least one compound comprising a functional group able to polymerise.

In a second aspect, the invention concerns the use of such a treatment fluid for consolidating unconsolidated or weakly consolidated granular porous substrates of a formation without simultaneous substantial loss of permeability or the use of such treatment fluid for shale stabilising.

In a third aspect the invention concerns a method for consolidating an unconsolidated or a weakly consolidated granular porous substrate without simultaneous substantial loss of permeability, comprising the following steps:—providing a treatment fluid comprising a solvent, a surfactant, in a concentration sufficient to form admicelles at the surface of grains of said substrate, and at least one compound containing a functional group able to polymerise;—injecting said treatment fluid into said porous substrate;—allowing admicelles to be formed at the surface of the grains; and—polymerising said compound.

### BRIEF DESCRIPTION OF THE DRAWINGS

The invention will be better understood in the light of the following description of non-limiting and illustrative embodiments, given with reference to the accompanying drawings, in which:

FIG. 1A and 1B schematically illustrate the distribution of the surfactant molecules of the treatment fluid in a granular porous substrate where the surfactant concentration is lower or, respectively, greater than its bulk critical micelle concentration;

FIG. 2 is a schematic representation of the consolidation process according to the invention;

FIG. 3 illustrates, schematically, the way in which the length scale of the polymer glue can be extended;

FIG. 4A, 4B and 5 are diagrammatic representations of the extent of consolidation of substrates treated with treatment fluids comprising, inter alia, DTAB or ω-DTAB;

FIG. 6A and 6B are diagrammatic representations of the extent of polymer precipitation in substrates treated with treatment fluids comprising DTAB or ω-DTAB;

FIG. 7A, 7B, 7C and 7D are FEG-ESEM images of consolidated samples according to the invention;

FIG. 8A, 8B and 8C are diagrammatic representations of the extent of consolidation of substrates treated with treatment fluids whose polymerisable monomer comprises DVB alone, styrene and a diene or DVB and a diene, respectively, the diene being 1,7-octadiene;

FIG. 9 is a photograph of a typical consolidated core after treatment of an unconsolidated sand pack according to the invention; and

FIG. 10A, 10B, 10C and 10D are further FEG-ESEM images of consolidated samples according to the invention.

### DETAILED DESCRIPTION

The object of the treatment fluid of the invention is to consolidate unconsolidated granular porous substrates without simultaneous substantial loss of permeability, in particular, toward oil and gas fluids. Typically, unconfined compressive strengths of 1000 psi are achieved with a retained permeability of 500 mD.

The unconsolidated or weakly consolidated granular porous substrate is notably a sandstone that may be found down hole in a formation and which tends to release sand grains in a well bore alongside with oil, water and gas. The average diameter of the sand grains is comprised between about 0.1 and about 1.5 mm. However, numerous porous substrates have been used for experiments, including substrates constituted by particles of a large range of diameter, as given in the table 1 below:

TABLE 1

| Substrate | Description |
|---|---|
| Hepworth Sand | Very clean sand, little clay present. |
| | Source: Hepworths |
| See sand | Acid washed sand, white quartz |
| | Source: Aldrich (297-210 μm diameter) |
| Clashach | Quarried sandstone, low clay content (<4%) |
| Berea | Quarried sandstone, high clay content (˜10%) |
| Silica | Synthetic silica, 1.5 μm diameter |
| | Source: Lancaster Chemicals |
| Silica-alumina | Classed as catalyst, has a cation exchange |
| | sites |
| Alumina | Activated (˜1000 μm, Surface Area = |
| | 155 m²/g). Source: Aldrich |

Clashach and Berea substrates are deconsolidated prior to experiments using a pestle and mortar.

The treatment fluid of the invention comprises a solvent. Said solvent is preferentially water or water-based, in particular, salt water from a range of salt concentrations from fresh water to those typical of seawater.

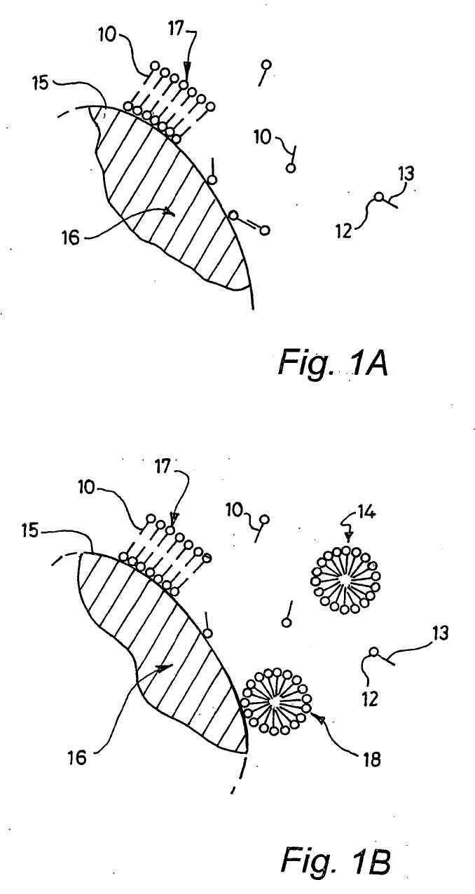

The treatment fluid of the invention also comprises a surfactant 10. Said surfactant 10 comprises both a hydrophilic 12 and a hydrophobic 13 region and has preferentially an enhanced solubility in the solvent. Thus, it displays the following behaviour: at low concentration, it dissolves in said solvent but, at a fairly distinct concentration above that low concentration, named bulk critical micelle concentration (b-CMC), it aggregates into micelles 14. This is shown in FIG. 1B. As shown in FIG. 1A, between that low concentration and the b-CMC, the surfactant 10 naturally arranges itself on the surface 15 of the sand grains 16 to form admicelles 17 generally constituted by a bilayer of surfactant molecules, the solution being then substantially free of micelles 14 and containing essentially single surfactant molecules. According to the invention, the b-CMC of the surfactant is high and the surfactant is in a concentration sufficient to form admicelles 17 at the surface of the sand grains and preferentially in a concentration less than its b-CMC (FIG. 1A), thus reducing significantly the likelihood of a later bulk emulsion polymerisation. Alternatively, the invention can operate in a concentration region above the b-CMC, such that the small number of bulk micelles formed are largely adsorbed on free mineral surface of the grains, said micelles being referenced 18 in the FIG. 1B.

All known surfactants may be used according to the invention, including ionic and non-ionic surfactants. Cationic and non-ionic surfactants are however preferred, since the substrate is generally negatively charged, as is normally the case for silica sand grains under operational conditions.

The surfactant advantageously comprises a functional group able to polymerise. Such a functional group can be a double bond, which is, for example, a terminal alkene functional group located at the termination of its hydrophobic tail. This enables surfactant molecules to be incorporated chemically into the polymer film as a co-monomer. There is evidence that this results in effective consolidation at lower surfactant concentrations compared to the saturated analogue.

Examples of surfactants are presented in the table 2 below. They are added in the treatment fluid under the form of salts:

TABLE 2

| | 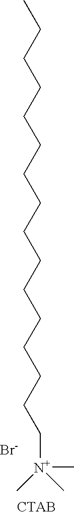 | 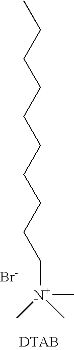 | 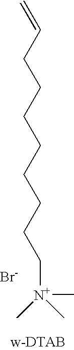 | 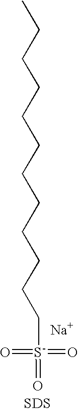 |
|---|---|---|---|---|
| Solubility | Low | High | High | High |
| in water | | | | |
| b-CMC | 9.2 × 10⁻⁴ M | 6.8 × 10⁻² M | 5.3 × 10⁻² M | 8.4 × 10⁻³ M |

CTAB, DTAB and ω-DTAB are alkyl trimethyl ammonium, where the alkyl group is a saturated or an unsaturated chain comprising at least 10 carbon atoms. CTAB is cetyltrimethylammonium bromide and DTAB and ω-DTAB are, respectively, decyltrimethylammonium bromide and decenyltrimethylammonium bromide. ω-DTAB contains a terminal double bound. CTAB, DTAB, as well as SDS (sodium dodecyl sulfate), have the advantage of being easily commercially available.

The pH of the treatment fluid is preferentially adjusted according to the surfactant used. For example, CTAB, which is a cationic surfactant, preferentially requires a negative charged surface of the grains for an optimum adsorption. That is why, in the case of a CTAB use, the pH of the treatment fluid is adjusted to a pH greater than 7, such as pH 8.

The treatment fluid of the invention further comprises at least one compound containing a functional group capable of polymerising. As shown above, this compound can be the surfactant itself. However, it can also be any monomer or oligomer, which can dissolve in the admicelles or adsorbed micelles and polymerise by an emulsion-polymerisation process. Preferentially, the monomer (or the oligomer) contains an unsaturated double bound, which can polymerise via a free radical chain process. Examples of monomers are styrene or divinylbenzene (DVB). However, monomers polymerising via a step-growth or nucleophilic substitution process may be used as well, for example bifunctional —OH compounds such as diols reacting with compounds containing quarterly ammonium —CH₂—R₃N⁺ groups.

According to the invention, the treatment fluid further comprises an initiator of the polymerisation. Any free radical initiator can be used for monomers which polymerise via a chain growth process. This is the case, in particular, of azoisobutyronitrile (AIBN), azodiisobutyamidedine dihydrochloride (AIBA) and sodium persulfate (NaPS). Water-soluble initiators, like NaPS, are preferentially used, as the solvent is generally water-based. It is however understood that all other initiator systems may also be used to initiate the polymerisation, even radiation systems. Ethanol is preferentially added to the treatment fluid in order to facilitate the solubilisation of monomers of limited water solubility such as styrene. All water-ethanol mixtures can be used. A 50:50 water-ethanol mixture is however preferable.

Advantageously, the treatment fluid further comprises an organic molecular chain with polymerisable end groups as, for example, dienes, notably 1,7-octadiene.

The treatment fluid of the invention is used, in particular, for consolidating unconsolidated or weakly consolidated granular porous substrates of a formation without simultaneous substantial loss of permeability.

For such a use, the method for consolidating of the invention comprises various steps.

In a first step a treatment fluid comprising at least a solvent, a surfactant, in a concentration sufficient to form admicelles at the surface of grains of the unconsolidated granular porous substrate, and a compound containing a functional group able to polymerise, is provided. The compound containing the functional group able to polymerise may be the surfactant itself or a monomer (or an oligomer) or a mixture of monomers. The treatment fluid may also further comprise all the compounds described above and, in particular, ethanol, the initiator or the organic molecular chain with polymerisable end group.

In a further step according to the invention, the treatment fluid is injected into the unconsolidated granular porous substrate to an appropriate depth.

This further step may need to precede by a pre-flush injection step intended to, notably, remove residual oil in near well bore regions and ensure rock grains are water-wet. Also, the components of the treatment fluid may be injected separately, for example, in the following order: surfactant, monomer and initiator, or in any sequential combination.

If the concentration of surfactant is equal to or above its surface critical micelle concentration s-CMC, it is sufficient to form a thin adsorbed admicelle layer of surfactant molecules, typically of a few nanometers thick, on the surface of the grains of the substrate. The admicelle layer is then swollen by the monomer and the initiator polymerises said monomer, predominantly on the surface of the grains. Subsequently, the admicelle layer is converted to a thin polymer layer, causing the grains to adhere at their points of contact and to consolidate into a three-dimensional structure having significant mechanical strength. Because the s-CMC, at which the admicelle layer forms, is advantageously well below the b-CMC, at which surfactant micelles form in bulk, bulk emulsion polymerisation in the rock pore space, which is the major cause of permeability reduction, is avoided at a surfactant concentration lower than its b-CMC. Moreover, because the polymer layer is very thin, it occupies very little of the bulk pore space and consolidation is achieved without significantly reducing the rock permeability below that of the original weakly consolidated formation. Alternatively, a similar situation can be achieved at concentration of surfactant which are low but slightly above b-CMC. Here, the concentration of bulk admicelles is sufficiently small that they are mainly adsorbed onto free rock grains surface, complementing the admicelles as surface polymerisation loci but still avoiding bulk emulsion polymerisation in the bulk pore volume which significantly reduces the matrix permeability on consolidation.

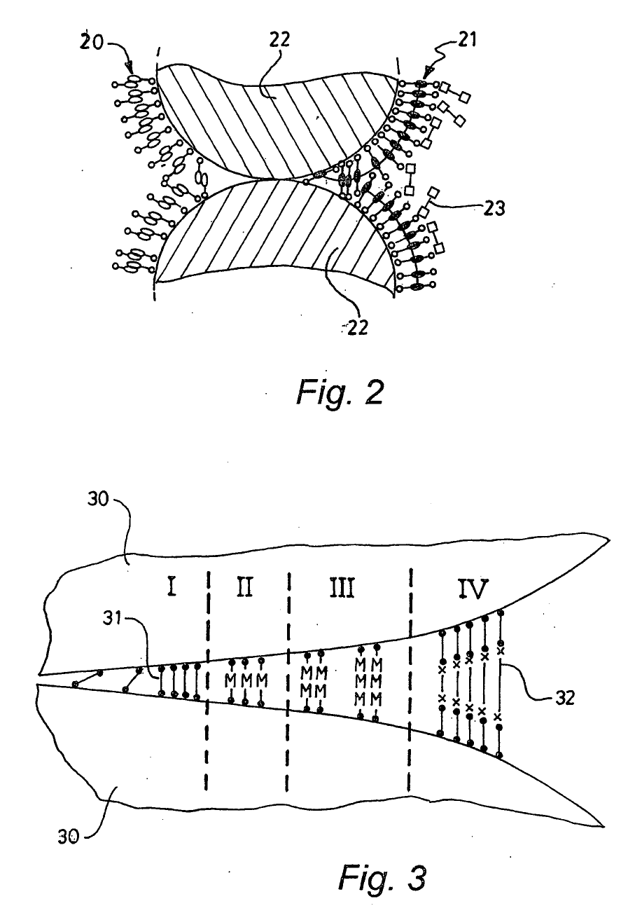

The FIG. 2 is a schematic representation of this process. The initial admicelle formation 20 is shown on the left of this figure. These admicelles 20 contain for example styrene, divinylbenzene or other monomers in order to produce the coherent film 21 shown on the right. The surfactant molecules are very much smaller than the sand grains 22 and will pack much more tightly at the sand grain contact point than depicted in the figure. The use of diols 23 to add across and extend the polymerised admicelles 21 is an additional step that may be implemented.

The FIG. 3, is a diagrammatic representation of the ways in which the length scale of the polymer glue can be extended. The simplest system I involves the creation of a polymer film by the polymerisation of the admicelles that had formed on the sand grains 30 using surfactants 31 that have a functional group capable to polymerise. Other systems II and III involve the polymerisation of monomers M present in admicelles. The incorporation of a polymerisable surfactant acting as a co-monomer would increase the amount of polymer coating and hence improve the extent of consolidation. In system IV, the organic molecular chains with polymerisable end groups 32 bridge across the admicelles that have previously been formed on the grains. Polymerisable inorganic molecular chains, for example, silane or Al(OR)₃, would have the same effect.

The polymerised bilayer may present a surface of cationic charges derived from the outer layer of the initial non-polymerised admicelle. If the chemical nature of the polar head group is sufficiently reactive, then the outer layer of the polymerised bilayer will be able to react with suitable nucleophiles. In such a case, quaternary ammonium (R₃N⁺—CH₂—) surfactants are particularly appealing, since the functional group binds strongly to the surface of silica and is also an excellent leaving group for nucleophilic substitution reactions. Thus, the reactivity of the outer layer of the polymerised admicelle provides an excellent opportunity for linking admicelles on adjacent grains via the reaction of, for example, long-chain diols, under alkaline conditions. In this type of copolymerisation process, it will be impossible to fill the larger cavities between the sand grains, because the covalent link can only be formed between an —CH₂—R₃N⁺ group and an —OH group. Hence, the permeability of the consolidated material will not be adversely affected and there is no attendant risk of permanently impairing the permeability. Although the difunctional, nucleophilic link group could react with the same admicelle layer, there is a sufficient number of intergrain links to give improved levels of consolidation. This may also extend towards the use of higher functionalised polyalcohols, as more efficient intergrain bridging units. In particular, polyethylene and polypropylene glycols and their copolymers, which are widely used in oilfield chemistry and the safety implications are well understood and accepted polyalcohols. Direct use of a surfactant with quaternary ammonium groups at each end may facilitate this approach. Another plausible route is the use of polycationic oligomers, for example polydiallydimethylammonium, of RMM<5000 (extended length ca. 170 Å), which also offer exposed cationic groups.

### EXAMPLE 1

A range of solutions comprising the components shown in the following table 3 has been placed in a sealed sample vial containing 12 g of Hepworth sand.

TABLE 3

| | DTAB | ω-DTAB |
|---|---|---|
| Water | ≈11.488 ml | ≈11.488 ml |
| NaCl | 0.08M | 0.08M |
| Ethanol | 4.0M | 4.0M |
| Surfactant | Dx1 = 0.068M | Dx1 = 0.053M |
| | Dx1, x2, x3, x4, x5, | Dx0.33, x0.66, x1, |
| | x6 | x1.33, x1.66, x2 |
| Adjusted pH | 8 | 8 |
| Styrene | Sx1 = 0.0038M | Sx1 = 0.0038M |
| | Sx16, x24, x32 | Sx16, x24, x32 |
| Initiator | 0.5 g | 0.5 g |

The sequence of addition started on day 1, when the surfactant, NaCl, water and ethanol, for a total volume of 14 ml, were mixed with the sand and adjusted to pH 8 using 0.04 M NaOH. On day 2, the pH of the solution had usually decreased and so was readjusted to pH 8 before adding the styrene. The mixture was given a rolling shake, enough to solubilise the styrene and expose all the sand grains to the solution without producing foam, and then left to equilibrate for 48 hours. On day 4, the initiator was added as a 1 ml aqueous solution and then followed by a rolling shake. The sand was allowed to settle for two hours before placing the samples in an oven at 70° C.

NaCl was used in the mixture because it is known to stabilise the formation of admicelles on the surface of substrates. Moreover, whereas the concentration of salt is lower than that of sea water, salt is often present in a down-hole scenario and, in such case, it will probably be used as the diluent of the treatment fluid.

The extent of consolidation was determined by observing how easily the sand deconsolidated when the sample vials were shaken. Sand that was not consolidated could easily be disturbed by holding the sample vial horizontal and simply rolling the supernatant against the sand. If the sand remained consolidated during this action, but deconsolidated when shaken gently, then it was termed weakly consolidated. If the sand could withstand a medium strength of shaking, then it was termed to have a medium strength of consolidation. If the sand deconsolidated upon vigorous shaking, then it was termed strongly consolidated. A sample that could withstand vigorous shaking was termed consolidated.

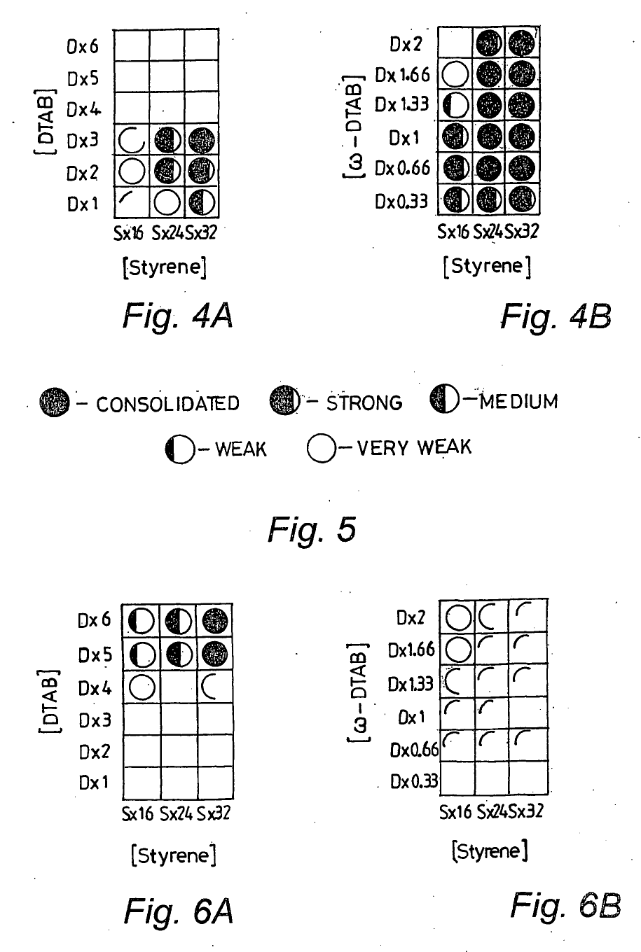

The FIG. 4A is a diagrammatic representation of the extent of sand consolidation using DTAB. As shown in the FIG. 5, the more a circle is shaded the greater the extent of consolidation or amount of precipitated polymer, whereas no circle indicates no consolidation or precipitated polymer. The strongest consolidation occurred when the concentration of DTAB and styrene was “D×3” and “S×32”, respectively. The second and third strongest consolidations occurred when the styrene concentrations were both “S×32” and the DTAB concentrations were “D×2” and “D×1”, respectively. In the FIGS. 6A and 6B, the more a circle is closed or shaded, the more precipitated polystyrene is observed in the supernatant. As shown in this figure, when the DTAB concentration is above “D×3”, precipitated polystyrene is observed in the supernatant so decreasing the matrix permeability. This indicates that, at high concentrations of DTAB greater than its b-CMC, the polymerisation of styrene occurred more predominantly in micelles than in admicelles.

FIG. 4B is a diagrammatic representation of the extent of sand consolidation using ω-DTAB. In that case, the strongest consolidation occurred when the concentration of ω-DTAB and styrene was “D×0.66”, or higher and “S×24” or “S×32”, respectively. As for DTAB, FIG. 6B shows that the amount of polymer that precipitated in the supernatant increased with increasing ω-DTAB.

A comparison of the extent of sand consolidation between DTAB and ω-DTAB results shows that, for comparable concentrations relative to the b-CMC, it is greater in the latter. This is particularly the case when the ω-DTAB concentration is equal to “D×1” and the concentration of added styrene is greater than “S×16”.

DRIFTS Infra-red analysis confirmed the presence of polystyrene on the surface of the consolidated sand grains. Thermogravimetric analysis (TGA) confirmed that the amount of polystyrene on the surface of the sand grains increased as the amount of consolidation increased and that it was highest in the most consolidated samples with TGA weight losses of ca. 1.5 wt %. In the presence of bulk emulsion polymerisation, the surface polystyrene content seldom exceeded 0.5 wt %.

Field Emission Gun—Environmental Scanning Electron Microscopy (FEG-ESEM) analysis was carried out to provide a visual record of the polymer coating on washed and unwashed sand grains treated with the DTAB treatment fluid. It confirmed the presence of polystyrene on the surface of all the consolidated samples and that the porosity of the samples was retained for “D×1” to “D×3” samples in that there was no evidence of the polymer network extending into the inter-grains cavities.

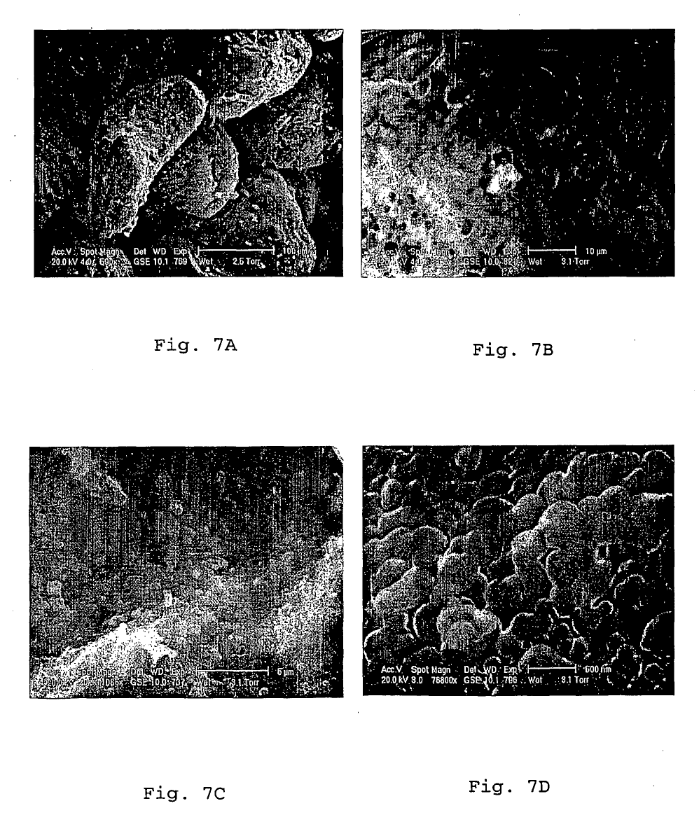

In particular, as shown in the FIG. 7A, the unwashed sand of the DTAB “D×1/S×32” sample, exhibited wispy needle-like structures, which are probably due to sulphate salts resulting from the degradation of the initiator. As shown in the FIG. 7B, the washed sand has an almost smooth continuous coating with occasional pitting in the surface, of thickness ranging from 2 to 20 μm in diameter. This structure is due to the polymerisation of styrene in admicelles and adsorbed micelles. As shown in the FIG. 7C, the unwashed sand of the DTAB “D×5/S×32” sample exhibits a carpet-like aggregation of small spheres, of less than 3-4 μm in diameter, coating the sand grains. As shown in the FIG. 7D, the washed sand exhibits a snake skin-like coating composed of small plate-like discs of less than 1 μm diameter. The spheres and disks are probably due to the presence of a large number of micelles in solution.

The amount of DTAB surfactant desorbed from the surface of the sand grains increased as the amount offered in the treatment fluid increased and it was not influenced by the amount of surface polymer. The amount of ω-DTAB followed the same trend but the quantities desorbed were only 20% of that of DTAB desorbed from corresponding samples. This suggests that the ω-DTAB was incorporated into the polymer film on the surface of the sand grains and explains the greater consolidation in the ω-DTAB systems.

### EXAMPLE 2

The consolidation performance can be enhanced by the use of other monomers or co-monomers. Experiments were executed using the same procedure as detailed in the example 1 with divinylbenzene (DVB) instead of styrene, with a diene in addition of styrene or with DVB and a diene instead of styrene. The treatment fluids experimented are defined in the table 4 below.

TABLE 4

| | | Styrene and | DVB and |
|---|---|---|---|
| | DVB alone | diene | diene |
| Sand | 12 g | 12 g | 12 g |
| Surfactant | Dx1, x2, x3 | Dx1, x2, x3 | Dx1, x2, x3 |
| (DTAB) | (D = 0.068M) | (D = 0.068M) | (D = 0.068M) |
| Ethanol | 77% | 77% | 77% |
| (% volume) | | | |
| Water | 23% | 23% | 23% |
| (% volume) | | | |
| NaCl | 0.08M | 0.08M | 0.08M |
| pH | 8 | 8 | 8 |
| Divinylbenzene | DVB x16, | — | DVB x32 |
| | x24, x32 | | (DVB = |
| | (DVB = | | 0.00593 g) |
| | 0.00593 g) | | |
| Styrene | — | Sx32 | — |
| Diene (1,7 | | DIx4, 8 & 16 | DIx4, 8, 16 |
| octadiene) | | | |
| Initiator (SP) | 0.5 g | 0.5 g | 0.5 g |
| Temp (° C.) | 70° C. | 70° C. | 70° C. |

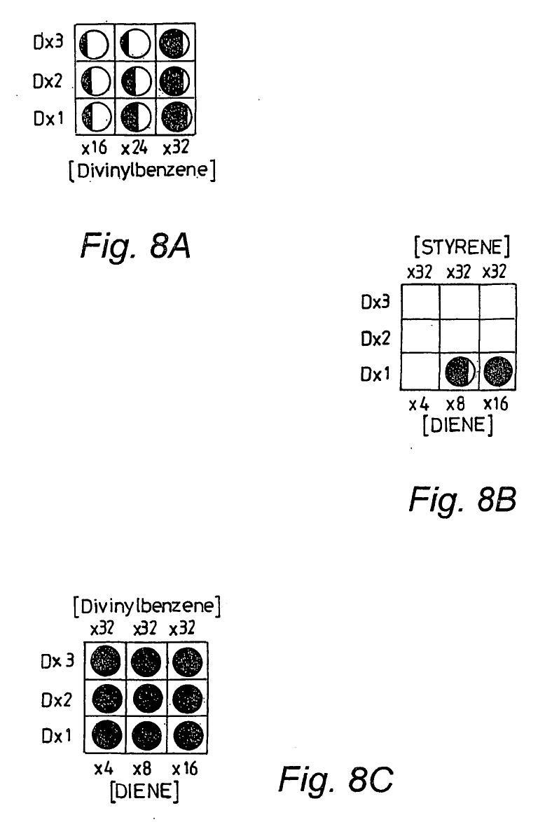

As shown diagrammatically in the FIG. 8A, if DVB is used instead of styrene, consolidation occurs as well. A comparison between the results obtained with styrene and those obtained with DVB permits to conclude that the consolidation is similar. As shown in the FIG. 8B and comparing the result shown by that figure to those obtained according to the example 1, if a diene, in particular 1,7-octadiene, is added to styrene, consolidation is improved. Adding a large quantity of diene has however a reverse effect. Finally, as shown diagrammatically in the FIG. 8C, if DVB and diene are added together, a complete consolidation occurs. That may signify that branched and 3-dimensional crosslinking of the polymer structure has significant advantages over linear polymer films.

### EXAMPLE 3

The sequence of addition of the reagents may have important effects and further experiments have therefore been done, by mixing all the components together prior to addition of the initiator and an ultimate addition of sand, by mixing all the components together prior to the addition of sand and a final addition of the initiator and after an equilibration period or by mixing the sand and all the components before addition of styrene and the initiator. When the components were added all together, weak consolidation occurred when the surfactant concentration was less than the b-CMC and at least six hours equilibration period was allowed after addition of said components to the sand and before addition of the initiator. However, good consolidation results were obtained when sand was mixed with all the components and before addition of styrene and of the initiator. It suggests that it is beneficial to allow admicelles to form on the sand prior to the addition of styrene, a preferential implementation of the method for consolidating unconsolidated substrates of the invention comprising accordingly two injection steps, a first injection step consisting in the injection of the treatment fluid without the monomer and/or initiator and a second injection step consisting in the injection of the monomer and/or initiator.

### EXAMPLE 4

Cylindrical polytetrafluoroethylene (PTFE) tubes of 2.5 cm internal diameter and 12 cm length were packed with 96 g of Hepworth sand and held in a vertical position before being preconditioned with an aqueous ethanol, 0.08 M NaCl-containing solution at pH equal to 8, sealed and then placed in an oven at 70° C. overnight before flowing the treatment. Treatment fluids were pumped to the bottom of the packs via a PTFE tubing of 0.8 mm internal diameter. The majority of the experiments were conducted using two sand packs in series after it was found that certain combinations of reagent flow rate and initiator concentration resulted in either no consolidation or only a small amount of consolidation at the top of a single sand pack, which is interesting because it offers the potential to place a treatment at a particular distance into a formation. DRIFT Infra-red spectroscopy analysis, thermogravimetric analysis (TGA) or FEG-ESEM was used to analyse the resulting loose or consolidated sand. Sections of the sand were separated and labelled with respect to the penetration depth of the treatment fluid into the sand pack. The bottom of the sand pack was denoted 0 cm and the top, 12 cm. The eventual subsequent sand pack, positioned in series, was denoted 12-24 cm. Detail of the experimental conditions and of the extent of consolidation obtained are presented in the Tables 5 and 6 below:

TABLE 5

| Sample | FT2 | FT9 | FT15 | FT16 |
|---|---|---|---|---|
| DTAB | 0.204M | 0.204M | 0.204M | 0.204M |
| | | | | (w-DTAB) |
| Ethanol | 23% | 23% | 23% | 23% |
| (% | | | | |
| volume) | | | | |
| Water | 77% | 77% | 77% | 77% |
| (% | | | | |
| volume) | | | | |
| Styrene | 0.12M | 0.12M | 0.12M | 0.12M |
| Initiator | 0.140M | 0.140M | 0.140M | 0.140M |
| (NaPS) | | | | |
| Temp | RT during | 70° C. | 70° C. | 70° C. |
| (° C.) | treatment | | | |
| | 70° C. bet. | | | |
| | Each 50 ml | | | |
| | (overnight) | | | |
| Flow rate | 2.5 | 2.5 | 1.0 | 1.0 |
| (ml/min) | | | | |
| Total | 4 × 50 ml/ | 250 ml | 750 ml | 930 ml |
| volume | (8) | (11) | (33) | (40) |
| (nb. of | | | | |
| pore | | | | |
| volumes) | | | | |
| Number of | 1 | 2 | 2 | 2 |
| sand packs | | | | |
| Extent of | 0-4 cm: | 0-4 cm: | 0-6 cm: | 0-6.5/7 |
| consol- | consolidation | consolidation; | very | cm: |
| idation | | 4-11 cm: | strong | consolidation |
| | | weak | consolidation; | 6.5/7- |
| | | consolidation | 6-12 | 9 cm: only |
| | | of | cm: | one side |
| | | patchy | very | of the |
| | | areas; | weak | pack |
| | | 12-24 cm: | consolidation; | consolidated |
| | | no | 12-24 | 12-24 cm: |
| | | consolidation | cm: no | no |
| | | | consolidation | consolidation |

TABLE 6

| | Sample | | | | |
|---|---|---|---|---|---|
| | | | | | FT22 |
| | FT17 | FT18 | FT19 | FT20 | ω-DTAB |
| Surfactant | 0.068M | 0.068M | 0.068M | 0.068M | 0.054M |
| Ethanol | 55% | 55% | 55% | 55% | 55% |
| (% volume) | | | | | |
| Water | 45% | 45% | 45% | 45% | 45% |
| (% volume) | | | | | |
| Styrene | 0.12M | 0.12M | 0.12M | 0.12M | 0.12M |
| Initiator | 0.140M | 0.014M | 0.014M | 0.07M | 0.014M |
| Temp (° C.) | 70° C. | 70° C. | 70° C. | 70° C. | 70° C. |
| Flow rate | 1.0 | 2.0 | 3.0 | 2.0 | 2.0 |
| (ml/min) | | | | | |
| Total | 1000 ml | 1000 ml | 1000 ml | 1000 ml | 1000 ml |
| volume | (44) | (44) | (44) | (44) | (44) |
| (nb. of | | | | | |
| pore | | | | | |
| volumes) | | | | | |
| Number of | 1 | 1 | 2 | 2 | 2 |
| sand packs | | | | | |
| Extent of | 0-7/7.5 cm: | 0-5 cm: | 0-17 cm: | 0-4 cm: | 0-12.5 cm: |
| Consolidation | consolidation; | no | no | no | no |
| | 7/7.5-12: | consolidation; | consolidation; | consolidation; | consolidation; |
| | no | 5-12 cm: | 17-24 cm: | 4-12 cm: | 12.5-23.5 cm: |
| | consolidation | consolidation | consolidation | consolidation; | consolidation; |
| | | | | 12-24 cm: | 23.5-24 cm: |
| | | | | no | no |
| | | | | consolidation | consolidation |

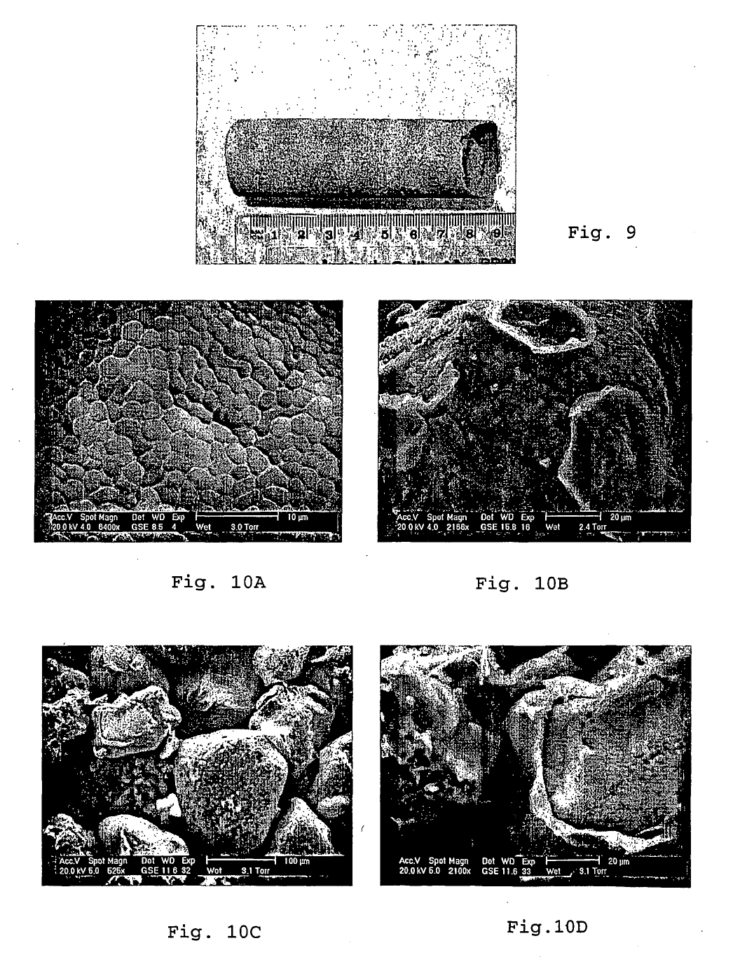

A typical consolidated core after treatment of an unconsolidated sand pack according to the invention is shown in the FIG. 9.

DRIFTS Infra-Red analysis proved that polymerisation had taken place. Thermogravimetric analysis of the amount of polystyrene associated with the samples indicated that there was generally more polymer on the outside of the cores and that the strength decreased as the amount of surface polymer went below 2 wt %, which was the upper limit of polymer content in the previous experiments.

FEG-ESEM visualisation of the consolidated sand packs indicated that the polymer coating has adopted differing morphologies depending on the chemistries and flow conditions utilised. An interesting feature is a mosaic pattern covering the entire surface of grains at the bottom and outside of the core of the sample FT17 as shown in the FIG. 10A, which is considered to illustrate the admicelles originally present on the surface of the sand grains in which polymerisation has taken place. The FEG-ESEM images also show that the polymer coated the sand grains and held the grains together. Indeed, saucer shaped protrusions are seen on top of some sand grains where an adjacent sand grain has been removed during sample recovery, as shown in the figure 10B relating to the sample FT2. The thickness of the polymer coating can be estimated as 0.5-1.0 μm from the FEG-ESEM images, but this can be no more than an estimate due to shadowing effects. The consolidation of sand grains by the thin polymer films and the absence of significant pore blocking by bulk polymer are clearly shown in the FEG-ESEM images of the FIGS. 10C and 10D of the top part of the sample FT19.

The range of depth over which consolidation of the core takes place is determined by the rate of polymerisation relative to the residence time of the various reagents in the core. These are determined in turn by the initiator half-life time, the temperature, the pH, the initiator solubility, the nature of the surfactant, the injection fluid flow rate and the volume of treatment fluid relative to the sand/rock pore volume. An appropriate control of these parameters enables the extent and position of consolidation to be controlled.

Then, permeability and strength tests were performed on the cores produced in samples FT16, FT17, FT18 FT19, FT20 and FT22. The results are shown in the table 7 below.

TABLE 7

| | Sample No: | | | | | |
|---|---|---|---|---|---|---|
| | 16 | 17 | 18 | 19 | 20 | 22 |
| Permeability/ | 500 | 2.5 | 1000 | 2000 | 930 | 1400 |
| mD | | | | | | |
| UCS/psi | 145 | 1211 | 814 | 353 | 61 | 80 |

Knowing that a non-treated sand pack has an unconfined UCS that is equal to 0 psi and a permeability that is equal to 6900 D, the above results show that the combination of a good core strength of several hundred psi with retained permeability near 1000 mD is achieved after treatment according to the invention.

The four- to six-stage process of the prior art can be replaced by a one- or two-stage injection process, possibly preceded by a conditioning pre-flush to aid adsorption of the surfactant on the rock, this making the invention more efficient, capable of implementation with much shorter interruptions to well production and eliminating the need for a subsequent fracturing.

1. Treatment fluid for consolidating or stabilising a substrate, comprising:
a solvent;
a surfactant, in a concentration sufficient to form admicelles; and
at least one compound comprising a functional group able to polymerise.

2. Treatment fluid for consolidating an unconsolidated or weakly consolidated granular porous substrate without simultaneous substantial loss of permeability, comprising:
a solvent;
a surfactant, in a concentration sufficient to form admicelles at the surface of grains of said substrate; and
at least one compound comprising a functional group able to polymerise.

3. Treatment fluid according to claim 2, wherein the unconsolidated or weakly consolidated granular porous substrate comprises sand grains or weakly consolidated sand grain aggregates.

4. Treatment fluid according to claim 1, wherein the solvent is water-based.

5. Treatment fluid according to claim 4, wherein the solvent is salt water from a range of salt concentrations from fresh water to those of sea water.

6. Treatment fluid according to claim 1, wherein the concentration of the surfactant is less than a few multiples of its bulk critical micelle concentration.

7. Treatment fluid according to claim 6, wherein the concentration of the surfactant is less than its bulk critical micelle concentration.

8. Treatment fluid according to claim 1, wherein the surfactant is cationic or non-ionic.

9. Treatment fluid according to claim 1, wherein the surfactant comprises a functional group able to polymerise.

10. Treatment fluid according to claim 9, wherein the functional group comprises a double bond.

11. Treatment fluid according to claim 10, wherein the double bond is part of an alkene functional group located at the termination of an hydrophobic tail of the surfactant.

12. Treatment fluid according to claim 1, wherein the surfactant is an alkyl trimethyl ammonium wherein the alkyl group comprises at least 10 carbon atoms.

13. Treatment fluid according to claim 12, wherein the surfactant is cetyltrimethylammonium, decyltrimethylammonium or decenyltrimethylammonium.

14. Treatment fluid according to claim 1, wherein the compound is a monomer, an oligomer or a mixture of a plurality of monomers and/or oligomers.

15. Treatment fluid according to claim 1, wherein the monomer or the oligomer is able to polymerise by an emulsion-polymerisation, a step-growth or a nucleophilic substitution process.

16. Treatment fluid according to claim 1, wherein the monomer or the oligomer contains an unsaturated double bond and is able to polymerise under a free radical chain process.

17. Treatment fluid according to claim 1, wherein the monomer is styrene or divinylbenzene.

18. Treatment fluid according to claim 1, further comprising an initiator of the polymerisation.

19. Treatment fluid according to claim 1, further comprising ethanol.

20. Treatment fluid according to the claim 18, wherein the initiator is a free radical initiator.

21. Treatment fluid according to claim 18, wherein the initiator is selected from the group consisting in azobutyronitrile, azodiisobutyamidedine dihydrochloride and sodium persulfate.

22. Treatment fluid according to claim 1, further comprising an molecular chain with polymerisable groups.

23. Treatment fluid according to claim 22, wherein the groups are located at the end of the molecular chain.

24. Treatment fluid according to claim 23, wherein the molecular chain with polymerisable end groups is a diene.

25. Treatment fluid according to claim 24, wherein the diene is the 1,7 octadiene.

26. Treatment fluid according to claim 22, wherein the molecular chain contains a quaternary ammonium group.

27. Use of a treatment fluid according to claim 22, for consolidating unconsolidated or weakly consolidated granular porous substrates of a formation without simultaneous substantial loss of permeability.

28. Use of a treatment fluid according to claim 1, for stabilising shale.

29. Method for consolidating an unconsolidated or weakly consolidated granular porous substrate without simultaneous substantial loss of permeability, comprising the following steps:
providing a treatment fluid comprising a solvent, a surfactant, in a concentration sufficient to form admicelles at the surface of grains of said substrate, and at least one compound containing a functional group capable to polymerise;
injecting said treatment fluid into said porous substrate;
allowing admicelles to be formed at the surface of the grains; and
polymerising said compound.

30. Method according to claim 29, wherein the compound is polymerised predominantly within the admicelles.

31. Method for consolidating according to claim 29, wherein the concentration of the surfactant is less than a few multiples of its bulk critical micelle concentration.

32. Method according to claim 31, wherein the concentration of the surfactant is less than its bulk critical micelle concentration.

33. Method according to claim 29, wherein the compound containing the functional group capable to polymerise is the surfactant.

34. Method according to claim 29, wherein the compound containing the functional group capable to polymerise is a monomer, a monomer mixture or an oligomer distinct from the surfactant.

35. Method according to claim 34, wherein the monomer(s) or the oligomer(s) swells the admicelles.

36. Method according to claim 29, further comprising the step of:
injecting an initiator of the polymerisation of the compound containing the functional group capable to polymerise.

37. Method according to claim 34, wherein the monomer is injected after injection of the surfactant and the initiator.
